(19) United States
(12) Patent Application Publication
(10) Pub. No.: US 2010/0155408 A1
(43) Pub. Date: Jun. 24, 2010

(54) TANK VENTILATION SYSTEM

(75) Inventors: Andreas Menke, Weingarten (DE); Benjamin Moser, Markt Indersdorf (DE)

Correspondence Address: HESPOS & PORCO LLP, 110 West 40th Street, Suite 2501, NEW YORK, NY, 10018, US

(73) Assignee: Dr. Ing. h.c.F. Porsche Aktiengesellschaft, Stuttgart (DE)

(21) Appl. No.: 12/559,790

(22) Filed: Sep. 15, 2009

(30) Foreign Application Priority Data
Dec. 20, 2008 (DE) 10 2008 064 347.5

(51) Int. Cl. B60K 15/035; F16K 17/02

(52) U.S. Cl. 220/746; 137/512

(57) ABSTRACT

A tank ventilation system for a motor vehicle has a fuel tank (4) and a pressure holding valve device (20) that function to maintain a slight positive pressure in the fuel tank (4) above fuel (8) in the fuel tank (4) by discharging an excess gas volumetric flow (16, 17). To optimize the tank ventilation system during fueling of the motor vehicle, the pressure holding valve device (20) has a throughflow cross section that is variable as a function of the discharged gas volumetric flow (16, 17) and increases with a rising gas volumetric flow (16, 17).

### CROSS-REFERENCE TO RELATED APPLICATIONS

This application claims priority under 35 USC 119 to German Patent Application No. 10 2008 064 347.5 filed on Dec. 20, 2008, the entire disclosure of which is incorporated herein by reference.

### BACKGROUND OF THE INVENTION

1. Field of the Invention

The invention relates to a tank ventilation system for a motor vehicle.

2. Description of the Related Art

A motor vehicle has a fuel tank and a pressure holding valve device that functions to maintain a slight positive pressure in the fuel tank above a fuel quantity which is situated in the fuel tank by discharging an excess gas volumetric flow.

It is an object of the invention to optimize a tank ventilation system during operation, in particular during fueling of the motor vehicle.

### SUMMARY OF THE INVENTION

The invention relates to a tank ventilation system for a motor vehicle. The motor vehicle has a fuel tank and a pressure holding valve device that maintains a slight positive pressure in the fuel tank above the fuel in the fuel tank by discharging an excess gas volumetric flow being discharged. The pressure holding valve device has a throughflow cross section that is variable as a function of the discharged gas volumetric flow and increases with a rising gas volumetric flow. It has been determined in the context of the present invention that fuel filled into the fuel tank during fueling of the fuel tank with a pump nozzle brings about a pressure increase that can lead to undesirable premature switching off of the pump nozzle. This could be ascribed to the fact that a backpressure exerted by the pressure holding valve device increases with a rising discharged gas volumetric flow in such a way that the gas volumetric flow can no longer be discharged quickly enough. However, the throughflow cross section of the pressure holding valve device of the invention increases. As a result, the gas volumetric flow increases or becomes greater during fueling and can be discharged quickly enough. Thus, the undesirable premature switching off of the pump nozzle is prevented reliably. It is essential that the throughflow cross section increases in a manner to control the throughflow as a function of the discharged gas volumetric flow.

The pressure holding valve device preferably comprises a plurality of pressure holding valves that are connected in parallel and through which flow passes as a function of the discharged gas volumetric flow. Flow passes through only one pressure holding valve in the case of a low or normal gas volumetric flow. At least one further pressure holding valve can be connected in the case of a rising gas volumetric flow, and flow then likewise passes through the at least one further pressure holding valve. As a result, a stepped change in the throughflow cross section is made possible as a function of the discharged gas volumetric flow.

The pressure holding valves that are connected in parallel preferably are configured as identical parts. Thus, an identical series valves preferably are connected in parallel.

The pressure holding valve device preferably comprises an opening and/or closing mechanism that enables a continuous adjustment of the throughflow cross section as a function of the discharged gas volumetric flow. The throughflow cross section of the pressure holding valve device increases continuously with a rising gas volumetric flow, and vice versa.

The opening and/or closing mechanism of the pressure holding valve device may comprise a closing body that is prestressed by a spring and is actuated as a function of the pressure in the fuel tank to change the throughflow section continuously. For example, the closing body can be moved to a greater or lesser extent into an outlet line of the fuel tank or out of the output line to reduce or to increase the throughflow cross section in the region of the closing body.

The pressure holding valve device may comprise at least one bypass through which flow passes as a function of the discharged gas volumetric flow. The bypass is closed in the case of a normal or low gas volumetric flow and is opened as the gas volumetric flow rises.

The pressure holding valve device additionally may comprise a vacuum valve. The vacuum valve functions to dissipate an undesirable vacuum in the fuel tank. The integration of the vacuum valve into the pressure holding valve device simplifies the construction and/or the assembly of the tank ventilation system.

The invention also relates to a motor vehicle having the above-described tank ventilation system. The tank ventilation system reduces an undesirable development of vapor in the fuel tank during operation, in particular in the case of fueling. The motor vehicle preferably is a vehicle with a start/stop system or a hybrid vehicle. An activated charcoal filter can be connected behind the pressure holding valve device to avoid fuel vapors escaping from the fuel tank. The activated charcoal filter preferably functions to receive and clean the fuel vapors before the discharged gas volumetric flow passes into the surroundings. For example, a positive pressure of 25 HPa (hectopascals) is considered to be a slight positive pressure in conjunction with the present invention. The pressure holding valve device of the invention preferably is in an output line between the fuel tank and the activated charcoal filter or the surroundings. The pressure holding valve device preferably is closed below a positive pressure limiting value of, for example, 25 HPa and is open above the limiting value. Fuel vapors from the fuel tank can pass into the activated charcoal filter and possibly the surroundings only when the pressure holding valve device is open. Thus, the tank ventilating system enables a fueling operation in which the fuel vapor displaced by new fuel that is poured in can flow out of the fuel tank quickly and against an approximately constant backpressure.

Further advantages, features and details of the invention result from the following description, in which different exemplary embodiments are described in detail with reference to the drawings.

### BRIEF DESCRIPTION OF THE DRAWINGS

FIG. 1 is a greatly simplified schematic illustration of a tank ventilation system in accordance with the invention with a pressure holding valve device.

FIG. 2 is a schematic illustration of a pressure holding device that enables a stepped change in the throughflow cross section.

FIG. 3 is a schematic illustration of a pressure holding valve device that enable a continuous change in the throughflow cross section.

### DETAILED DESCRIPTION OF THE PREFERRED EMBODIMENTS

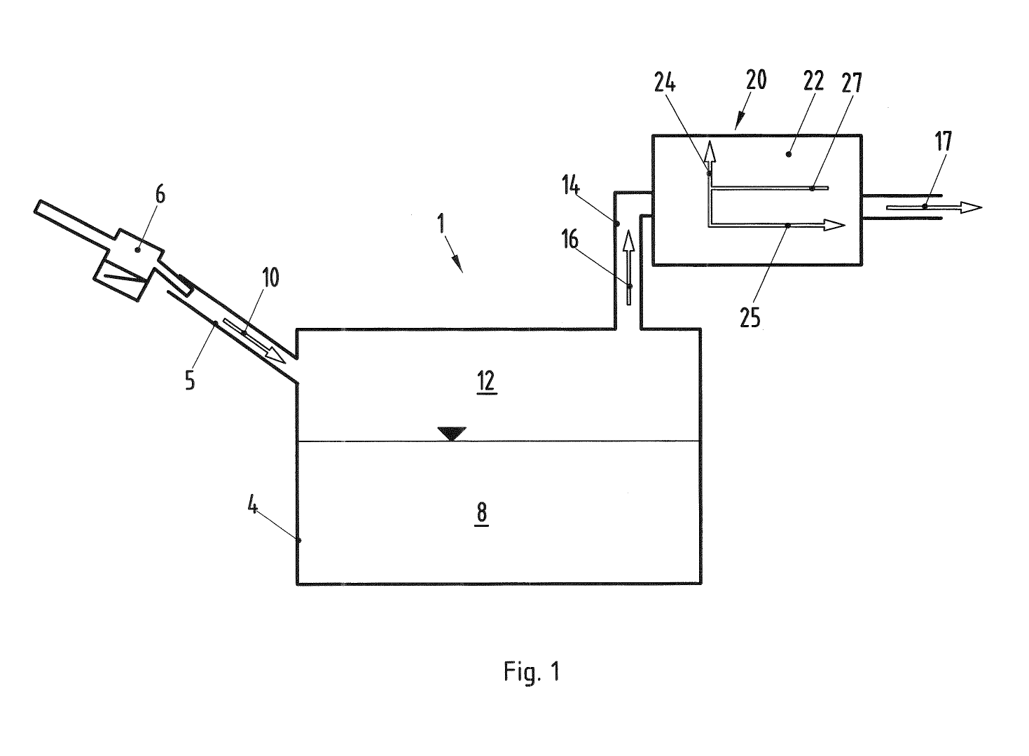

A motor vehicle tank ventilation system in accordance with the invention is identified by the numeral 1 in FIG. 1. The motor vehicle is preferably a vehicle with a start/stop system or a hybrid vehicle having a fuel tank 4 or fuel container with a filler neck 5 for pouring in fuel. A pump nozzle 6 of a fueling device (not shown), for example a filling pump of a filling station, is plugged into the filler neck 5. The arrow 10 indicates how the fuel passes from the pump nozzle 6 into the fuel tank 4 during fueling. The fuel 8 contained in the fuel tank 4 collects in the lower region of the fuel tank 4 due to gravity and a gas volume 12 is enclosed in the fuel tank 4 above the fuel 8.

The fuel tank 4 desirably is pressurized to reduce an undesirably high vapor formation in the fuel tank 4 during operating and fueling. The fuel tank 4 therefore is prestressed with the aid of at least one pressure holding valve that is loaded with a slight positive pressure. Secondly, the fuel tank 4 is protected with the aid of a vacuum safety valve against an excessively great vacuum that could make the fuel tank 4 contract in an undesirable manner.

An output line 14 emanates from the upper side of the fuel tank 4. The output line 14 enables a gas volumetric flow to flow out of the gas volume 12, as indicated by arrows 16 and 17, if a limiting value for the positive pressure in the fuel tank 4 is exceeded. For this purpose, a pressure holding valve device 20, which is indicated by a rectangle 22, is provided in the output line 14. The gas volumetric flow 16, 17 that flows out preferably is fed to a cleaning device that comprises, for example, an activated charcoal filter. The cleaned gas volumetric flow then passes, for example, into the surroundings where ambient pressure prevails.

A Cartesian coordinate diagram is drawn in the rectangle 22 with a Y-axis 24, on which pressure in the fuel tank 4, for example in bar, is plotted, and with an X-axis 25, on which the throughflow quantity is plotted, that is to say the gas volumetric flow that is discharged by the output line 14. A straight line 27 parallel to the X-axis 25 indicates that pressure in the fuel tank 4, which is plotted on the Y-axis 24, remains virtually constant independent of the gas volumetric flow 16, 17 discharged into the surroundings.

The pressure holding valve device 20 ensures that a greater throughflow cross section, that is to say the pass-through cross section, is provided for the gas volumetric flow at higher gas volumetric flows. The greater throughflow cross section or pass-through cross section can be provided, for example, by at least one bypass being opened.

The pressure holding valve device 20 ensures in a simple way that the gas volume 12 that is displaced during fueling by the fuel 10 that flows in is discharged quickly and counter to a substantially constant resistance. The pressure holding valve device 20 preferably works in a range from 0 to 25 hectopascals or HPa. A desired low positive pressure can be held in the fuel tank 4 in a simple way by the pressure holding valve device 20, even during fueling, virtually independently of the gas volumetric flow 16, 17 that flows through the pressure holding valve device.

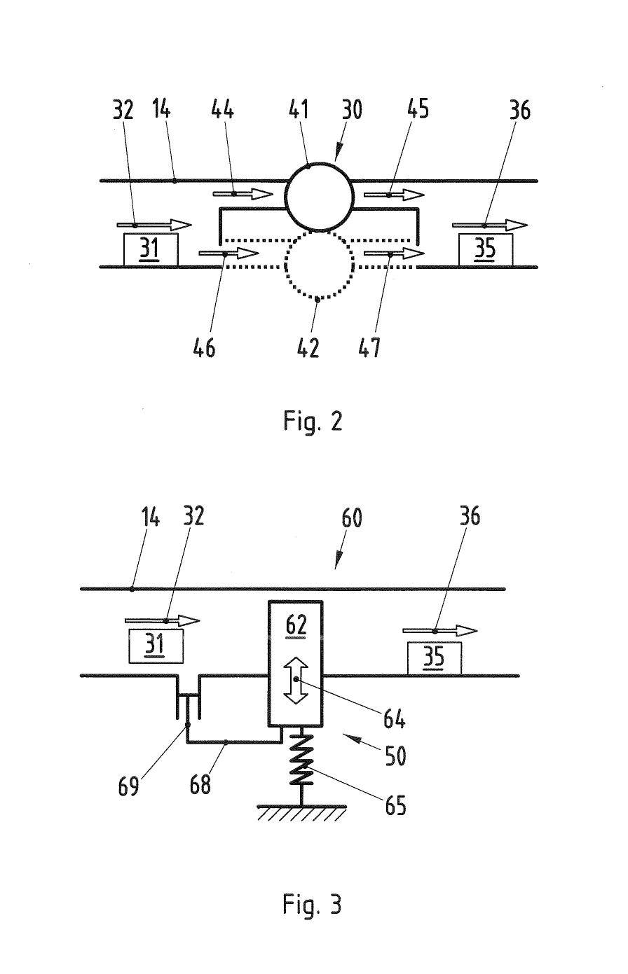

FIG. 2 shows a detail of the intake line 14 from FIG. 1 with a pressure holding valve device 30 according to a further embodiment. The rectangle 31 indicates that tank pressure, which is the pressure in the fuel tank 4, prevails in front of the pressure holding valve device 30 in the flow direction. The arrow 32 indicates the gas volumetric flow that is discharged from the fuel tank 4. The rectangle 35 indicates that ambient pressure prevails behind the pressure holding valve device 30 in the flow direction. The arrow 36 indicates the gas volumetric flow that is discharged into the surroundings.

The pressure holding valve device 30 comprises two pressure holding valves 41, 42 that are connected in parallel in the outlet line 14, as indicated by arrows 44 to 47. The two pressure holding valves 41, 42 are identical conventional pressure holding valves. The second pressure holding valve 42 opens only when an unsubstantially higher pressure is exceeded, induced by, for example, a construction-induced variance of the structurally identical pressure holding valves 41, 42, as a result of which a greater pass-through cross section is opened.

As a result, the throughflow resistance can be halved in comparison with the use of only one pressure holding valve, with an approximately identical prestress of the fuel tank. The throughflow resistance can be reduced step by step by the pressure holding valve device 30 according to the invention with the second pressure holding valve 42 at the same pressure, that is to say with the same prestress of the fuel tank. The two pressure holding valves 41, 42 have nominally identical pressure holding values.

FIG. 3 shows an embodiment with a pressure holding valve device 50 that has an opening and/or closing mechanism 60 in the outlet line 14. The pressure holding valve device 50 comprises a closing body 62 for opening or closing the intake line 14.

The exposed opening cross section or pass-through cross section can be adjusted with the aid of the closing body 62 continuously and in an infinitely adjustable manner as is indicated by the double arrow 64. The closing body 62 is prestressed by a spring 65, for example into its open position, and is actuated by a control device 68 and a pressure control element 69 is loaded with the tank pressure. As an alternative, an electric actuator can be provided instead of the spring 65 and can be connected to a pressure sensor 69 via an electric control line 68.

According to a further aspect of the invention, a vacuum safety valve, as described above, can be integrated into the pressure holding valve device 20; 30; 50. A single conventional vacuum safety valve to dissipate an undesirable vacuum in the fuel tank is sufficient which is accommodated, for example, with the two pressure holding valves 41, 42 in a common valve housing.

What is claimed is:

1. A tank ventilation system for a motor vehicle, having a fuel tank and a pressure holding valve device configured to maintain a slight positive pressure in the fuel tank above a fuel quantity in the fuel tank by discharging an excess gas volumetric flow, the pressure holding valve device having a throughflow cross section that is variable as a function of the gas volumetric flow being discharged and increases with a rising gas volumetric flow.

2. The tank ventilation system of claim 1, wherein the pressure holding valve device comprises a plurality of pressure holding valves that are connected in parallel and through which flow passes as a function of the gas volumetric flow being discharged.

3. The tank ventilation system of claim 2, wherein the pressure holding valves that are connected in parallel are identical to one another.

4. The tank ventilation system of claim 1, characterized in that the pressure holding valve device comprises an opening/closing mechanism that makes a continuous adjustment of the throughflow cross section as a function of the gas volumetric flow being discharged.

5. The tank ventilation system of claim 4, wherein the opening/closing mechanism of the pressure holding valve device comprises a closing body that is prestressed by a spring and is actuated as a function of the pressure in the fuel tank to change the throughflow cross section continuously.

6. The tank ventilation system of claim 1, wherein the pressure holding valve device comprises at least one bypass, through which flow passes as a function of the gas volumetric flow being discharged.

7. The tank ventilation system of claim 1, wherein the pressure holding valve device comprises a vacuum valve.

8. A motor vehicle having the tank ventilation system of claim 1.
